(19) United States
(12) Patent Application Publication
(10) Pub. No.: US 2013/0129159 A1
(43) Pub. Date: May 23, 2013

(54) FACE RECOGNITION METHOD AND APPARATUS

(71) Applicants: Ronald Huijgens, (US); Rulger Storm, (US)

(72) Inventors: Ronald Huijgens, (US); Rulger Storm, (US)

(21) Appl. No.: 13/301,958

(22) Filed: Nov. 22, 2011

(51) Int. Cl. G06K 9/62

(52) U.S. Cl. 382/118

(57) ABSTRACT

A facial recognition system, method and computer readable medium for improved facial recognition. The facial recognition system includes an image pre-processing module configured to receive a subject facial image and one or more reference facial images. The image pre-processing module is configured to perform pose and lighting correction processing on the subject facial image and on the reference facial images. The facial recognition system also includes a face matching module configured to perform facial recognition analysis of the corrected subject facial image with one or more reference facial images. The facial recognition system also includes an output module configured to receive facial recognition results from the face matching module. The output module is configured to manage the operation of the face recognition system including the operation of the face recognition system based on the facial recognition results received from the face matching module.

### BACKGROUND

1. Field

The instant disclosure relates generally to face recognition, and more particularly, to improved methods and systems for face recognition using face image enhancements.

2. Description of the Related Art

Face recognition methods and systems are being used more frequently than in the past, e.g., for security purposes at airports and border control locations. In recent years, major advances have occurred in face recognition. Many conventional face recognition systems and methods often can achieve a recognition rate of approximately 90-95% in optimal conditions. However, in many real world applications and environments, it often is difficult to capture a face image that is of suitable quality for use in a face recognition system. For example, face images often are subject to a number of external conditions, such as illumination, occlusion and face angle. That is, many face images used for face recognition are taken in poor or improper lighting conditions and/or at improper or even unacceptable face angles, often causing shadows and/or hidden face surfaces and other forms of occlusion. Such external conditions often reduce the overall recognition rate of many conventional face recognition systems. Also, the captured face image may include various facial expressions that often can reduce the quality of the face image for face recognition purposes.

Some conventional face recognition systems perform or provide some form of pre-processing to the face images used in their face recognition methods. For example, some conventional face recognition systems eliminate areas surrounding the face in the image to better situate the face within the overall image. However, many conventional face recognition systems do not provide any pre-processing or other image correction measures to face images used in their face recognition systems.

Other conventional techniques used to improve the quality of captured face images involve the use of moving (height-adjustable) 2D cameras or the use of three dimensional (3D) cameras, followed by subsequent image processing to produce suitable quality face images. However, such instruments typically are relatively expensive and the subsequent processing is relatively time-consuming and processor-intensive.

There are many applications in which face recognition methods and systems could benefit from improved or corrected face images, e.g., face images having improved face angles, lighting and resolution.

### SUMMARY

Disclosed is a facial recognition system, method and computer readable medium. The facial recognition system includes an image pre-processing module configured to receive a subject facial image and one or more reference facial images. The image pre-processing module is configured to perform pose and lighting correction processing on the subject facial image to generate a corrected subject facial image. The image pre-processing module also is configured to perform pose and lighting correction processing on one or more of the reference facial image to generate corresponding corrected reference facial images. The facial recognition system also includes a face matching module coupled to the image pre-processing module and configured to perform facial recognition analysis of the corrected subject facial image with one or more reference facial images. The facial recognition system also includes an output module coupled to the face matching module and configured to receive facial recognition results from the face matching module. The output module is configured to manage the operation of the face recognition system including the operation of the face recognition system based on the facial recognition results received from the face matching module.

### BRIEF DESCRIPTION OF THE DRAWINGS

FIG. 1 is a schematic view of a facial recognition system, according to an embodiment;

FIG. 2 is a schematic view of a multithreading process using two job queues used in the facial recognition system of FIG. 1, according to an embodiment;

FIG. 3 is a schematic view of the classes used in the facial recognition system of FIG. 1, according to an embodiment;

FIG. 4 is a flow diagram of a method for facial recognition, according to an embodiment;

FIG. 5 is a graphical view of a False Reject Rate (FRR) of the facial recognition system of FIG. 1, according to an embodiment;

FIG. 6 is a graphical view of a False Accept Rate (FAR) of the facial recognition system of FIG. 1, according to an embodiment;

FIG. 7 is a graphical view of a Receiver Operator Characteristic (ROC) of the facial recognition system of FIG. 1, according to an embodiment;

FIG. 8 is a schematic view of a facial recognition system, in identification mode, according to an embodiment; and

FIG. 9 is a schematic view of a facial recognition system, in verification mode, according to an embodiment.

### DETAILED DESCRIPTION

In the following description, like reference numerals indicate like components to enhance the understanding of the disclosed facial recognition method and apparatus through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

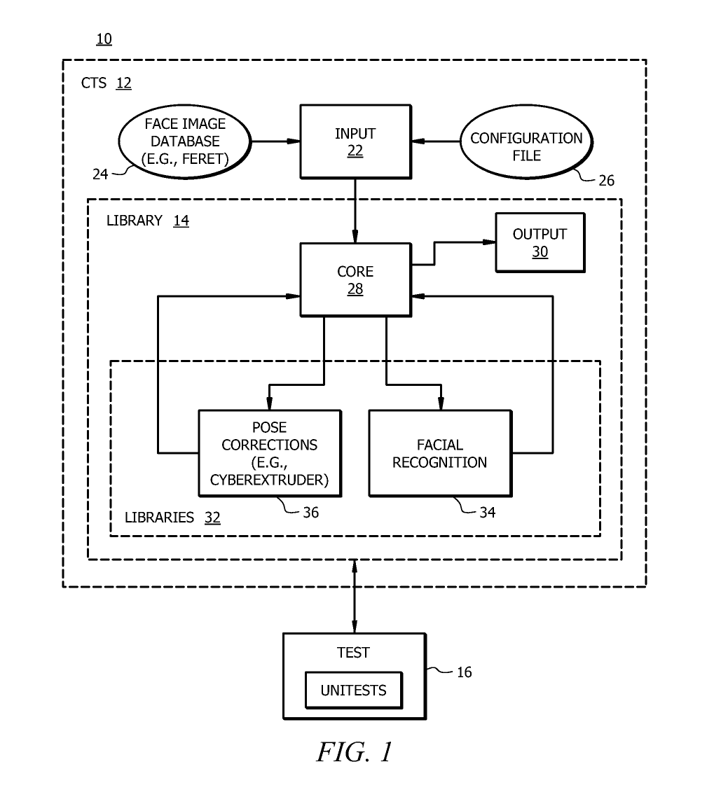

FIG. 1 is a schematic view of a facial recognition system 10 according to an embodiment. As will be discussed in greater detail hereinbelow, the facial recognition system 10 makes use of available processing modules to improve the appearance of a face image prior to that face image being used in any facial recognition processing. Rather than using conventional techniques to improve the quality of captured face images, the facial recognition system 10 uses available processing modules to improve the angle or pose and lighting of the face in the captured face image. The facial recognition system 10 also corrects for relatively poor lighting and/or resolution using available processing modules.

Using available processing modules, the facial recognition system 10 initially converts a two dimensional face image, e.g., a face image captured from a photo or camera or a photo scanner, into a three dimensional (3D) model or version of the face image. Then, using suitable processing modules, the 3D version of the captured face image can be rotated or otherwise adjusted to improve the pose and lighting of the face before the improved face image is converted back to a 2D image. Also, the lighting and overall image resolution can be improved on the 3D version of the capture face image before the improved face image is converted back to a 2D image. The improved 2D image then is used in appropriate facial recognition processing modules. Using the improved 2D image, facial recognition processing modules produce improved facial recognition results, without making use of relatively time consuming and expensive pre-processing used in conventional face recognition systems.

The facial recognition system described herein can be used in any suitable application. For example, the facial recognition system described herein can be used in an identification mode application, i.e., in which a captured subject or probe facial image is compared with a plurality of reference facial images (e.g., from a facial image database) to determine a match or potential match between the subject facial image and one or more of the reference facial images. Also, the facial recognition system described herein can be used in a verification mode application, i.e., in which a captured subject or probe facial image is compared with an associated known identity reference facial image (e.g., a passport image) to determine if the captured subject or probe facial image matches the associated known identity reference facial image. It should be understood that, in both identification mode and verification mode applications, the use of processing modules can be used to improve the appearance of the captured subject or probe facial images and/or one or more reference facial images.

The facial recognition system 10 and its operation can be viewed as or broken down into three parts: an input portion 12, such as a CTS (CyberExtruder Test Software) portion, a library portion 14, such as a CTSLib portion, and a test portion 16, such as a CTSTest portion. All or a portion of one or more of the input portion 12, the library portion 14 and the test portion 16 can be comprised partially or completely of any suitable structure or arrangement, e.g., one or more integrated circuits or processing modules.

The input portion 12 generally is the front end of the facial recognition system 10 and typically accepts data input into the facial recognition system 10. The input portion 12 also starts a processing loop in the library portion 14. The input portion 12 of the facial recognition system 10 includes an input module 22 that is coupled to and receives input information or data from a Facial Recognition Technology (FERET) Database 24 or other suitable source of one or more reference facial images. The FERET database 24 is a conventional database of facial images that often is used in many facial recognition applications. Additional data corresponding to the received facial images is input to the facial recognition system 10 through one or more configuration files 26, which are given to the facial recognition system 10 via command lines. The input module 22 parses the command lines and the configuration file input to the input module 22.

The library portion 14 of the facial recognition system 10 contains many of the core functions of the facial recognition system 10. The library portion 14 includes a core or core module 28 and an output or output module 30. The core module 28 typically includes and functions as the core application for the facial recognition system 10. For example, the core module 28 typically is responsible for starting the main processing loop, as well as distributing processing jobs that need to be performed. The core module 28 also manages the appropriate libraries 32, such as a Facial Recognition library 34 and a pose and lighting correction library 36, as will be discussed in greater detail hereinbelow. The core module 28 receives its input information from the input module 22. The output module 30 typically is responsible for generating or providing the results from the core module 28, e.g., as one or more files, such as a CSV (Comma-separated values) file.

The pose and lighting correction library 36 is the library that performs pose and lighting correction on one or more of the images input into the facial recognition system 10, e.g., via the input module 22. The pose and lighting correction library 36 can include any suitable pose and lighting correction modules, such as a conventional third party pose and lighting correction module, e.g., a CTS pose and lighting correction module. The Facial Recognition library 34 is the library that contains face recognition processing components and performs many of the face recognition processing tasks.

The test portion 16, e.g., a CTSTest portion, performs unit tests to test the functionality of the library portion 14. Therefore, the communication between the test portion and the library portion is bi-directional. The test portion 16 also can be used to ensure processing quality and can be used as a post-build event to determine if any functional processing modifications that may be implemented actually compromise other existing functional processing.

Units tests are performed to make sure that the classes, which define the executable software modules, do not have unexpected or undefined behavior. The test functionality in the test portion 16 can be used to implement unit tests. Each unit test for a class typically is separated in a file with a suitable name convention, e.g., <class>_test.cpp. The test cases are globally sorted in the following categories: Constructors, Data accessors, function returns and Type checking. Also, there are some case-specific test cases, e.g., Length tests, Iterator testing and Operator testing. This is to make sure that no run-time errors are encountered once testing has been started.

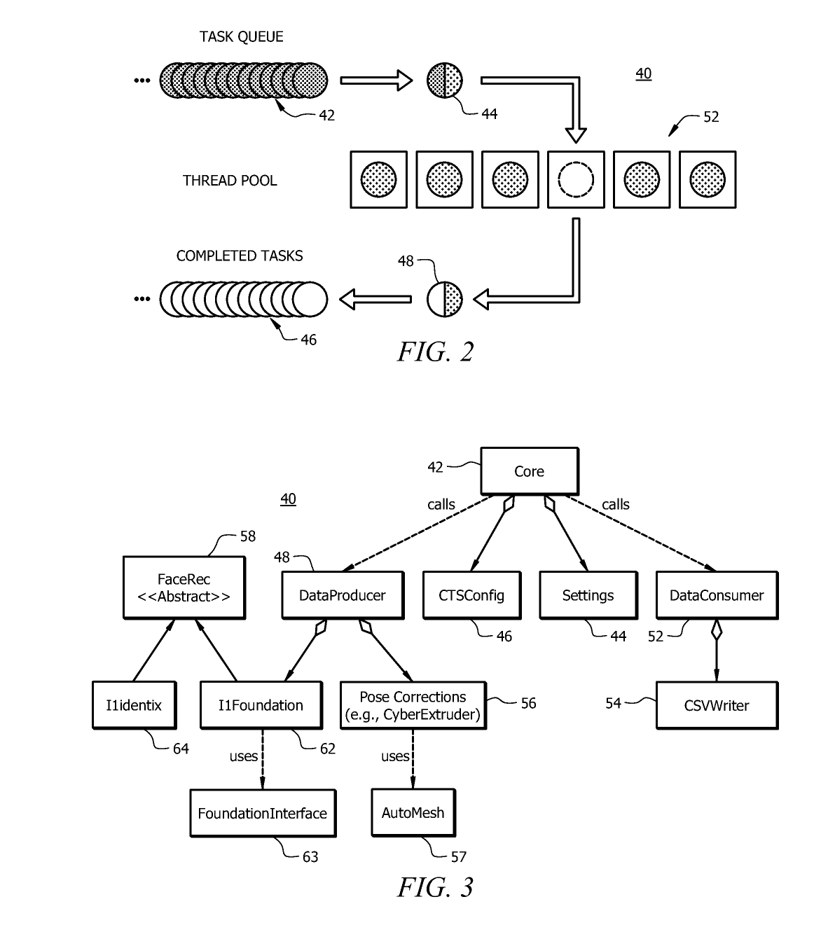

The processing involved in all or a portion of the facial recognition system 10 can make use of multithreading and/or other parallel processing techniques to improve testing efficiency. FIG. 2 is a schematic view of a multithreading process 40 used in the facial recognition system of FIG. 1, according to an embodiment. The multithreading process 40 includes a task queue 42 of processing jobs or tasks 44 to be performed and a completed tasks queue 46 of tasks or jobs 48 that have been completed.

For example, two job queues can be used to manage the handling of processing tasks or jobs. The first job queue is a thread pool 52. The purpose of the thread pool 52 is to keep the threads alive to prevent the overhead associated with destroying and creating threads. Sleeping threads take almost no processing resources, but creating a new thread does take processing resources. Therefore, if there are a relatively large number of small processing jobs and those jobs all had to start a new thread, those jobs collectively would degrade the overall performance of the facial recognition system 10.

In the job queue that is the thread pool 52, a processing job or task is pushed on the queue in the form of a functor, and the thread pool 52 assigns a thread to perform that particular job or task. By using functors, there is no restriction on the type of job or task to be performed, and therefore the thread pool job queue 52 is enabled to handle different job types on the same queue.

The second job queue is a shared queue (not shown), which makes use of a mutex and of condition variables to be able to use the shared job queue between several threads. This shared job queue is used to queue the vectors with strings that need to be written to the CSV (comma-separated values) file. The shared job queue itself holds data of the type that represents the test data, e.g., a DataRecord type, which is a specialized data type made to represent the test data.

FIG. 3 is a schematic view of the classes or class modules 40 used in the testing of the facial recognition system 10, according to an embodiment. The classes are implemented in the library portion 14 of the facial recognition system 10.

The classes include a core class 42, which is responsible for starting the main processing loop between the core module 28 and the libraries, i.e., the facial recognition library 34 and the pose and lighting correction library 36. The core class 42 also is responsible for setting up the threading and starting up the threads that are to be used in the thread pool. The core class 42 then distributes the queue jobs that need to be performed. Starting the threads this early in the overall process typically means that there will be no associated overhead later on when test scenarios are being performed.

The classes also include a settings class 44 and a CTS Config class 46. The settings class 44 is a parser that parses the parameters of the input command line received by the input module 22 and gives a meaning to the command line parameters. The settings class 44 is separated from the CTS Config class 46 to ensure that the system stays modular and to also ensure that the settings class 44 meets the requirements of cohesion (i.e., single-responsibility principle). The CTS Config class 46 is a parser that parses the configuration file received by the input module 22 based on a particular format, such as the configuration file format described hereinbelow.

The classes also include a DataProducer class 48. The DataProducer class 48 produces data, e.g., the test data needed to make a test report. The DataProducer class 48 also uses the face recognition library 34 and the pose and lighting correction library 36 to generate the data. The DataProducer class 48 includes various functions, such as CE_Match, CE_Quality, Match and Quality, which will be described in greater detail hereinbelow.

Once the DataProducer class 48 has generated data, e.g., in the form of a DataRecord, the DataProducer class 48 gives the data, via a SynQueue, to a DataConsumer class 52. The DataConsumer class 52 changes or edits the data received from the DataProducer class 48 into data that can be handled by a CSVWriter class 54. The CSVWriter class 54 writes vectors of strings to a filename set in the configuration file. The strings are separated by a delimiter, which typically defaults to “,” but can be changed to any suitable delimiter by using the supplied functions.

The classes also include a pose and lighting correction class 56, such as a CyberExtruder class. The pose and lighting correction class 56 uses appropriate processing to communicate with an AutoMesh processing module 57 to perform appropriate preprocessing. The output generated by the pose and lighting correction class 56 is an image, which can be saved in an appropriate location, e.g., on disk storage space in a temporary directory.

The classes also include a FaceRec class 58. The FaceRec class 58 is a pure abstract class to give a blueprint of the functions needed by a face recognition class. The FaceRec class 58 ensures that the testing program is relatively adaptable to be used with different face recognition processing modules with relatively few modifications.

The classes also include an L1 Foundation class 62. The L1 Foundation class 62 is a class derived from the abstract FaceRec class 58. The L1 Foundation class 62 follows the blueprint of the FaceRec class 58. Also, the extra functions of the L1 Foundation class 62 are private, thus ensuring that only the interface defined in the FaceRec class 58 is exposed. Therefore, it is relatively easy to replace the L1 Foundation class 62 with another class derived from the FaceRec class 58. In this manner, the interface to the FaceRec class 58 stays generic and separated from the other class modules.

The classes also include an L1identix class 64. The L1identix class 64 is a predecessor of the L1Foundation class 62. The L1Foundation class 62 shows how different face recognition processing can be implemented.

The configuration files input to the facial recognition system 10 can have any suitable format that is recognized by the facial recognition system 10. Also, each configuration file includes a number of option parameters for use by the various components and processing modules in the facial recognition system 10. For example, each configuration file can include a test mode option indicating the type of test to be performed using the image associated with the configuration file, e.g., a False Accept Rate (FAR) test, a False Reject Rate (FRR) test, a CyberExtruder False Accept Rate (CEFAR) test, a Quality test, or other suitable tests that comply with the configuration format, including customized tests. Also, each configuration file can include a FERETPath option indicating the path to the FERET reference images.

Each configuration file can include other options, such as whether or not to use CyberExtruder pose and lighting correction processing (or other suitable pose and lighting correction processing), the amount of images for comparison, whether or not to use saved templates for generated output files, the path to those saved templates, the output directory for generated output files and how many processors (cpus) to use.

Other options that may be used depend on the type of test being used. For example, if the Quality test type is chosen, there is no need to fill in the amount of images because the Quality test assesses the quality of all of the images that are frontal and quarter turned. However when the FAR test is chosen, the number of images needs to be defined because the FAR test uses the image amount setting to determine the sample size and how many images need to load for the test.

The FAR test measures the False Accept Rate. The False Accept Rate is the probability that the facial recognition system 10 incorrectly matches the input pattern to a non-matching template in the database. The FAR measures the percentage of invalid inputs that are incorrectly accepted. The value of the FAR varies between 0 and 100% and it is desirable to get the FAR value as low as is possible. A relatively low FAR value means that there is a relatively low chance the facial recognition system 10 will fail to distinguish identities.

To measure the False Accept Rate, every image of a person in the dataset is matched against all of the images of the different persons in the dataset. Only the images of different persons are matched, which means that if there is a match it will be a false accept. The percentage of the total False Accept is called the False Accept Rate. The FAR test excludes matches where the images of the same person are compared. Also, it should be understood that FTEs (Failure to Enroll) are not included. FTE is the rate at which attempts to create a template from an input is unsuccessful. The most common cause for FTE is relatively low quality inputs. However, it also is possible that the image becomes corrupt while trying to the make the template.

The FRR test measures the False Reject Rate. The False Reject Rate is the probability that the facial recognition system 10 fails to detect a match between the input pattern and a matching template in the database. The FRR measures the percentage of valid inputs that are incorrectly rejected. The value of the FRR also varies between the range 0 and 100% and, as with the FAR, the FRR value also is desirable to have as low as possible. A relatively low FRR value means that the recognition between images of the same person is increased.

To measure the False Reject Rate, every image of a person is compared to other images of the same person. The percentage of the found non-matches is called the False Reject Rate. This is because only images of the same person are compared. This is a relatively small dataset per person, since, on average, a person may have only six or seven images in the database. The FRR test uses the whole database.

The implementation of the FRR test scenario has a few requirements. For example, the implementation of the FRR test scenario involves only images of the same person, so those images should be grouped together. Also, any one person can not be used two or more times. To meet these requirements, a map<string, vector<string>> can be used to contain the images. The basis for the use of such map<string, vector<string>> is that a map has the following characteristics: each element has a unique key and each element is composed of a key and a mapped value.

The CEFAR test measures the False Accept Rate using the CyberExtruder testing software and test modules. The implementation of the CEFAR test is the same as the FAR test implementation, except that after completing the FAR test, the CEFAR test uses the same dataset to perform a second run, but with the CyberExtruder pose and lighting correction processing enabled.

As discussed hereinabove, the DataProducer class 48 includes various functions, such as CE_Match, CE_Quality, Match and Quality, that are important for data generation. Each of the CE_Match and the CE_Quality functions first apply the CyberExtruder or other appropriate pose and lighting correction preprocessing on or against the subject images. After the preprocessing is complete, the particular function passes the preprocessed images to the Match function or the Quality function, respectively. The pose and lighting correction preprocessing includes the ability to correct the pose to a full frontal pose, correct lighting and render a new two dimensional (2D) image.

The Match function receives two images and matches the images against each other. The Match function uses the functions of the face recognition processing specified at the start of the processing. The Match function passes its results to the writing queue to be written to the report file.

The Quality function performs quality checks on the subject image. Similar to the Match function, the Quality function uses the functions of the face recognition processing specified at the start of the processing. Also, the Quality function passes the results to the writing queue.

With respect to these functions, there are two differences that should be noted: the difference between the functions CE_Match and Match, and the difference between the functions CE_Quality and Quality. When the CE_Match and the CE_Quality functions are used, these functions first apply the pose and lighting correction preprocessing on or against the subject images. This preprocessing generates a three dimensional (3D) head and corrects the pose and lighting to a neutral frontal pose with corrected lighting, which includes removed shadows. After such preprocessing is performed, these functions call the Match or Quality function and pass the preprocessed images as parameters.

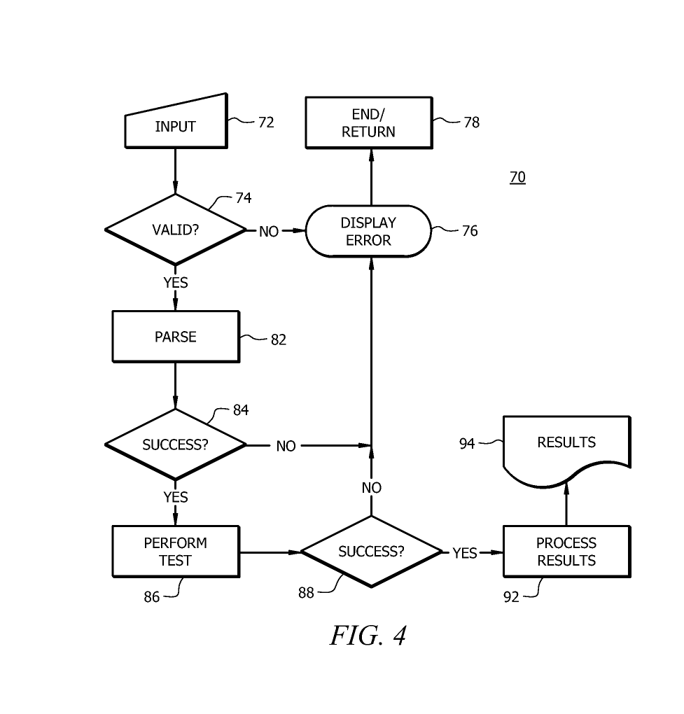

FIG. 4 is a flow diagram of a method 70 for facial recognition, according to an embodiment. With continuing reference to the facial recognition system 10 in FIG. 1, the method 70 includes a step 72 of receiving input data. As discussed hereinabove, the input module 22 of the facial recognition system 10 receives input information or data from the FERET Database 24 or other suitable database of reference facial images. The input module 22 of the facial recognition system 10 also receives face image information through one or more configuration files 26, which are given to the facial recognition system 10 via command lines.

The method 70 also includes a step 74 of determining whether or not the received input data is valid data. If the determining step 74 determines that the input data is not valid data (N), the method 70 proceeds to a step 76 of displaying an error message. The method 70 then either ends or returns to the start of the method 70, which is shown generally as an end/return step 78.

If the determining step 74 determines that the input data is valid data (Y), the method 70 proceeds to a step 82 of parsing the input data. As discussed hereinabove, the input module 22 parses the command lines and the configuration file.

The method 70 also includes a step 84 of determining whether or not the parsing operation or step 82 was performed successfully. If the determining step 84 determines that the input data parsing operation was not performed successfully (N), the method 70 proceeds to the step 76 of displaying an error message. The method 70 then either ends or returns to the start of the method 70 (i.e., the end/return step 78). If the determining step 84 determines that the input data parsing operation was performed successfully (Y), the method 70 proceeds to a step 86 of performing the appropriate test.

For example, as part of the test performing step 86, as discussed hereinabove, available pose correction and/or lighting and/or resolution processing can be used to improve the appearance of a face image prior to that face image being used in any facial recognition processing. In an identification mode application, available image improvement processing can be used to enhance the quality of a captured subject or probe facial image as well as one or more of a plurality of reference facial images from a facial image database. In a verification mode application, available image improvement processing can be used to enhance the quality of a captured subject or probe facial image and/or an associated known identity reference facial image (e.g., a passport image).

As discussed hereinabove, the configuration files input to the facial recognition system 10 include a test mode parameter that indicates the type of test to be performed using the image associated with the configuration file. Therefore, based on the test mode information in the configuration file, the image associated with the configuration file can have any of the FAR test, the FRR test, the CEFAR test or the Quality test performed thereon.

The method 70 also includes a step 88 of determining whether or not the testing step 86 was performed successfully. If the determining step 88 determines that the testing was not performed successfully (N), the method 70 proceeds to the step 76 of displaying an error message. The method 70 then either ends or returns to the start of the method 70 (i.e., the end/return step 78). If the determining step 88 determines that the testing was performed successfully (Y), the method 70 proceeds to a step 92 of processing the test results (shown generally as results 94).

In general, the use of the facial recognition method 70 as part of the facial recognition system 10 provides improved results compared to conventional facial recognition systems. The facial recognition method 70 and the facial recognition system 10 provide improved facial image quality, e.g., in terms of several image quality characteristics, such as improved resolution, more consistent lighting that improved lighting uniformity and reduced face shadows, reduced facial blurring, and improved facial poses. The improved quality of the facial images in turn improves the overall performance of facial recognition processes, in both identification mode applications and verification mode applications.

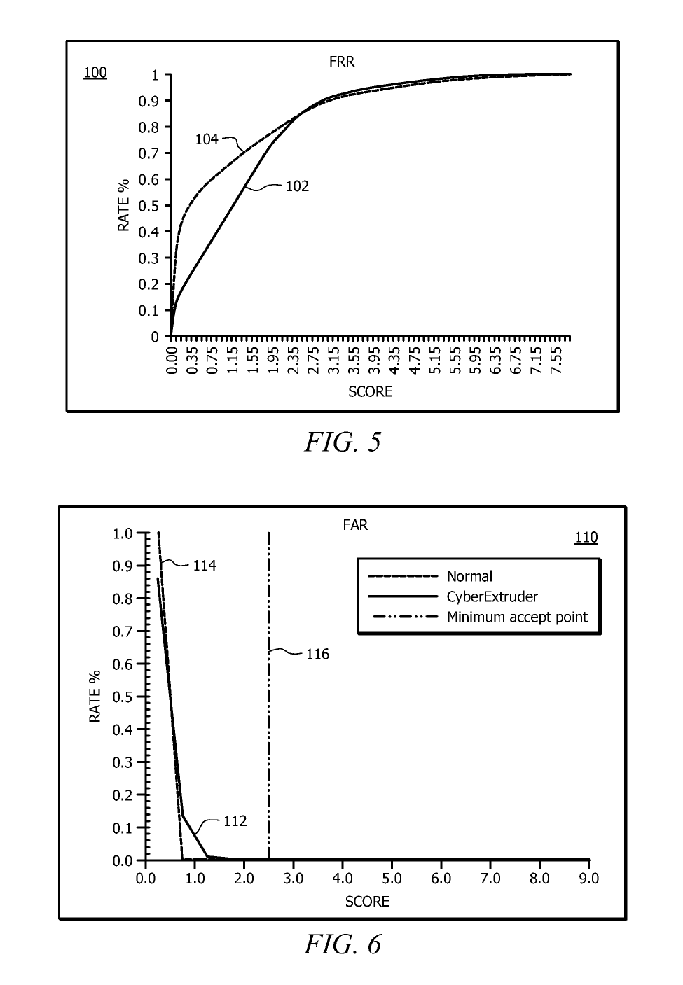

FIG. 5 is a graphical view 100 of the False Reject Rate (FRR) of the facial recognition system with pose and lighting correction preprocessing of FIG. 1 compared to conventional facial recognition systems without pose and lighting correction preprocessing. As discussed hereinabove, the FRR is the probability that the system fails to detect a match between the input pattern and a matching template in the database. The FRR measures the percentage of valid inputs that are incorrectly rejected. The FRR value varies between the range of 0-100%, and it is desirable for the FRR value to be as low as is possible. A relatively FRR value means that the recognition between images of the same person is increased.

The FRR graph 100 includes an FRR plot 102 for the use of the facial recognition method 70, which includes the pose and lighting correction preprocessing as part of the facial recognition system 10. The FRR graph 100 also includes an FRR plot 104 for a conventional facial recognition system without the pose and lighting correction preprocessing. As shown, the FRR plot 102 for the facial recognition method 70 and the facial recognition system 10 is lower than the FRR plot 104 for the conventional facial recognition system without the pose and lighting correction preprocessing.

FIG. 6 is a graphical view 110 of the False Accept Rate (FAR) of the facial recognition system with pose and lighting correction preprocessing of FIG. 1 compared to conventional facial recognition systems without pose and lighting correction preprocessing. As discussed hereinabove, the FAR is the probability that the facial recognition system incorrectly matches the input pattern to a non-matching template in the database. The FAR measures the percent of invalid inputs which are incorrectly accepted. The FAR value varies between 0 and 100% and it is desirable for the FAR value to be as low as is possible. A relatively low FAR value means that there is a relatively low chance that the facial recognition system will fail to distinguish identities.

The FAR graph 110 includes an FAR plot 112 for the use of the facial recognition method 70, which includes pose and lighting correction preprocessing as part of the facial recognition system 10. The FAR graph 110 also includes an FAR plot 114 for a conventional facial recognition system without pose and lighting correction preprocessing, as well as a minimal acceptable score or point for an FAR. As shown, the FAR plot 112 for the facial recognition method 70 and the facial recognition system 10 degrades slightly compared to the conventional system FAR plot 114. However, the FAR plot 112 for the facial recognition method 70 and the facial recognition system 10 still is well below the minimum acceptable rate, which means the facial recognition method 70 and the facial recognition system 10 still will reject incorrect facial matches.

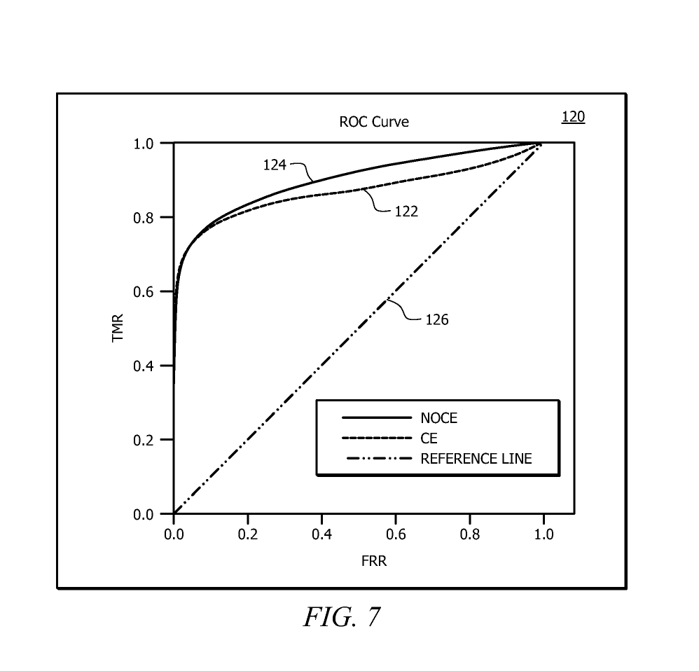

FIG. 7 is a graphical view 120 of a Receiver Operator Characteristic (ROC) of the facial recognition system of FIG. 1 compared to conventional facial recognition systems. The ROC shows the direct relationship between the FAR and the FRR. By plotting FAR against FRR, algorithm-specific scores are not used, which makes it possible to compare these curves produced using different facial matching module processing. By plotting the FAR against the FRR, results of the facial recognition method 70 as part of the facial recognition system 10 can be compared to a conventional facial recognition system.

The ROC graph 120 includes an ROC plot 122 for the use of the facial recognition method 70 as part of the facial recognition system 10. The ROC graph 120 also includes an ROC plot 124 for a conventional facial recognition system, and a reference line 126.

The facial recognition system 10 described hereinabove typically is used to determine configuration settings for a facial recognition system that is used in one or more applications, e.g., in an identification mode application or a verification mode application.

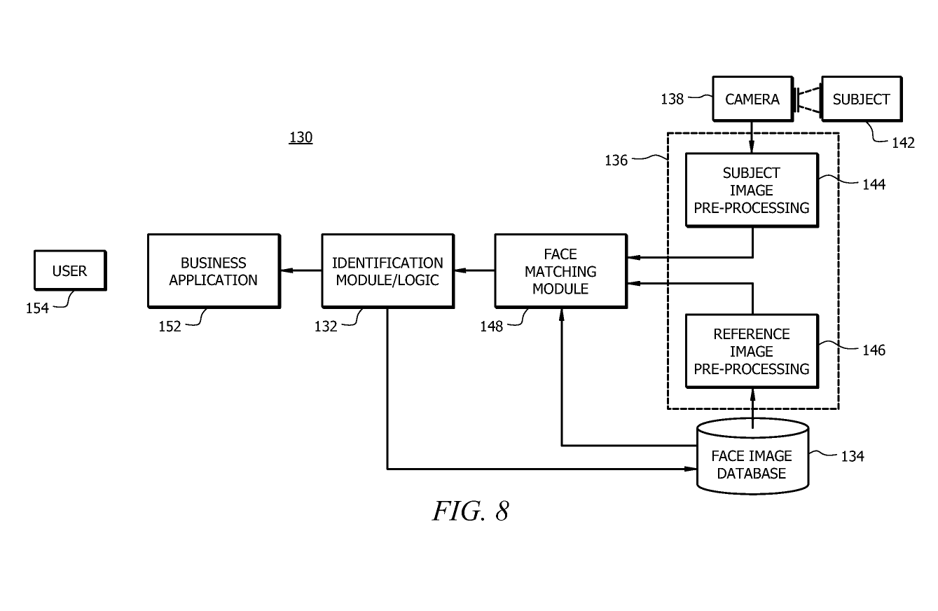

FIG. 8 is a schematic view of a facial recognition system 130, in identification mode, according to an embodiment. In general, the facial recognition system 130, in identification mode, uses a biometric Identity identification system based on face recognition, using any suitable 2D face recognition process module to find a ranked list of reference images that have an associated known identity, and a subject or probe face image that is captured live using a 2D still camera or using a frame captured from a video stream.

The facial recognition system 130 includes an identification module or logic core 132, which provides system logic and workflow necessary to meet the requirements of the facial recognition system 130. The identification module 132 is coupled to a face image database 134, such as a FERET database, for selecting various reference images from the database during the operation of the facial recognition system 130.

The facial recognition system 130 also includes an image pre-processing module or logic 136, which is configured to perform image pre-processing, e.g., as discussed hereinabove, to improve captured face images. The image pre-processing module or logic 136 can be used to improve a subject or probe image, e.g., a subject or probe image captured by a camera 138 of a subject 142. Subject image pre-processing is shown generally as a subject image pre-processing module 144. The image pre-processing module or logic 136 also can be used to improve a reference image, e.g., a reference image provided or supplied by the face image database 134. Reference image pre-processing is shown generally as a reference image pre-processing module 146.

The image pre-processing module 136 is configured to provide appropriate pose-image-, resolution- and possibly facial expression correction on the reference image, the probe image, or both, depending on the quality of the available images according to the configuration settings that have been determined using the facial recognition system 10 to optimize the accuracy of the facial recognition system 130.

The facial recognition system 130 also includes a face matching module 148 coupled to the identification module 132 and the image pre-processing module 136. The face matching module 148 is configured to compare a subject image to one or more reference images for a possible match. The face matching module 148 can be configured to provide a ranked list of possible matches of reference images to the subject image, e.g., based on similarity scores of the facial matches. The face matching module 148 provides the ranking list to the identification module 132, which makes the ranking list available to a suitable a business application 152 and/or a user. The ranking list is used by the user and/or a machine within the business application 152 to associate an identity to the subject image. Because of the nature of the preprocessing, the probability of not identifying a candidate in the list typically is lower than without using preprocessing.

In general, the facial recognition system 130 has a number of features or functions. For example, the facial recognition system 130 can be used to identify people captured as a subject image, to yield a greater true match rate (TMR) compared to conventional facial recognition systems. The facial recognition system 130 also can be used to check a watch list (e.g., criminal suspects), to yield a lower false on-match rate (FNMR) compared to conventional facial recognition systems. The facial recognition system 130 also can be used to de-duplicate a facial database, i.e., find more duplicates within a reference image database, more readily than conventional facial recognition systems. The facial recognition system 130 also can be used for forensic research, i.e., to find more possible subject/reference candidates. In forensic research, it typically is necessary to provide both original and (pre-processing) corrected face images, as only the original face images can be used in court proceedings.

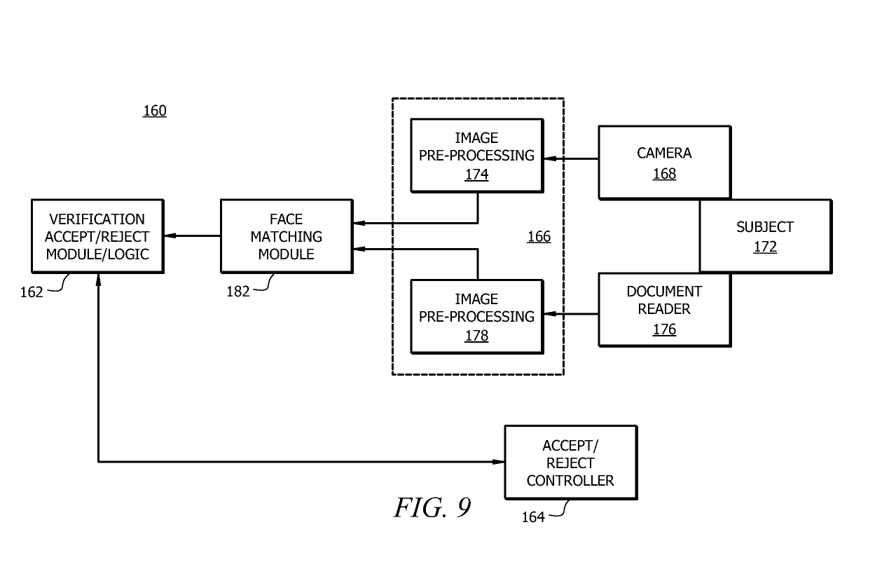

FIG. 9 is a schematic view of a facial recognition system 160, in verification mode, according to an embodiment. In general, the facial recognition system 160, in verification (or authentication) mode, uses a biometric Identity verification system based on face recognition, using any suitable 2D face recognition process module to measure the similarity score between a reference image that has an associated known identity, and a subject or probe face image that is captured live using a 2D still camera or using a frame captured from a video stream.

The facial recognition system 160 includes a verification or accept/reject module or logic core 162, which provides system logic and workflow necessary to meet the requirements of the facial recognition system 160. The verification module 162 is coupled to an accept/reject controller 164, which is configured to allow or disallow a subject to gain entrance or otherwise be accepted based on the accept/reject determination made by the verification module 162 and delivered to the accept/reject controller 164. For example, the facial recognition system 160 can be implemented at a security checkpoint gate, e.g., at an airport, and the accept/reject controller 164 can be a gate or other appropriate device or apparatus that allows a potential airline passenger to be admitted into the airport terminal.

The facial recognition system 160 also includes an image pre-processing module or logic 166, which is configured to perform image pre-processing, e.g., as discussed hereinabove, to improve captured face images. The image pre-processing module 166 can be used to improve a subject or probe image, e.g., a subject or probe image captured by a camera 168 of a subject 172. Subject image pre-processing is shown generally as a subject image pre-processing module 174. The image pre-processing module or logic 166 also can be used to improve a reference image, which typically has a known identity associated with the subject 172. The reference image can be retrieved from any data source, such as a database, a smart card, an epassport, and in any format, such as JPEG, BMP or other forms of encoding, such as a 2D barcode containing such an image. For example, the reference image can be an image captured by a document reader 176 or other appropriate device for reading or capturing an image from a document or other artifact, such as a passport, e.g., supplied by the subject 172 or other appropriate source. Reference image pre-processing is shown generally as a reference image pre-processing module 178.

The image pre-processing module 166 is configured to provide appropriate pose-image-, resolution- and possibly facial expression correction on the reference image, the probe image, or both, depending on the quality of the available images according to the configuration settings that have been determined using the facial recognition system 10 to optimize the accuracy of the facial recognition system 130.

The facial recognition system 160 also includes a face matching module 182 coupled to the verification module 162 and the image pre-processing module 166. The face matching module 182 is configured to compare a subject image to the reference image for a possible match. The face matching module 182 is configured to decide whether or not the subject image and the reference image originate from the same person, i.e., if the identity associated with the reference image belongs to the person on the probe image. The face matching module 182 provides the appropriate information to the verification module 162 for the verification module 162 to direct the accept/reject controller 164 to accept or reject the subject 172 accordingly.

In general, the facial recognition system 160 has a number of features or functions. For example, the facial recognition system 160 can be used to provide better verification decisions compared to conventional facial recognition systems that do not employ some type of image pre-processing or correction. The facial recognition system 160 also can be used to yield a lower False Reject Rate (FRR) compared to conventional facial recognition systems, which has the effect of reducing the cost of manually processing the face recognition process. The facial recognition system 160 also can be used to yield a lower False Accept Rate (FAR) that is equal to or better than the FAR of conventional facial recognition systems. Also, because of the potential improvement to subject and reference images, the facial recognition system 160 is less dependent on the environment and therefore can be implemented in more possible locations and at a lower cost than conventional facial recognition systems. Similarly, because of the potential improvement to reference images, the facial recognition system 160 is more tolerant of poorer quality reference images, e.g., paper passports.

According to an embodiment, the facial recognition systems described herein use pre-processing modules to improve the overall quality of images from individuals in various poses and under various lighting conditions, which may not all be full frontal and/or properly illuminated, for purposes of facial recognition by correcting the face pose and lighting. Also, the facial recognition systems described herein improve the template quality of images from individuals with various poses and lighting conditions, because the generated images tend to be more alike. Also, as discussed hereinabove, the facial recognition systems according to an embodiment generate a lower False Reject Rate (FRR) of a collection of images from individuals in various poses and under various lighting conditions, compared to conventional systems, because the facial recognition processing modules produce images that are better comparable. Also, it should be understood that in some cases the additional pre-processing performed can increase the overall processing time of the facial recognition system, although in many cases the time required to match two images did not increase using the facial recognition systems according to an embodiment. Also, facial recognition systems according to an embodiment tend to produce relatively higher quality images originally generated from relatively low quality image sources.

One or more of the modules in the facial recognition system 10 can be implemented in software, hardware, firmware, or any combination thereof. In certain embodiments, the module(s) may be implemented in software or firmware that is stored in a memory and/or associated components and that are executed by a processor, or any other processor(s) or suitable instruction execution system. In software or firmware embodiments, the logic may be written in any suitable computer language. One of ordinary skill in the art will appreciate that any process or method descriptions associated with the operation of the facial recognition system 10 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

The methods illustrated in FIG. 4 may be implemented in one or more general, multi-purpose or single purpose processors. Such processors execute instructions, either at the assembly, compiled or machine-level, to perform that process. Those instructions can be written by one of ordinary skill in the art following the description of FIG. 4 and stored or transmitted on a non-transitory computer readable medium. The instructions may also be created using source code or any other known computer-aided design tool. A non-transitory computer readable medium may be any non-transitory medium capable of carrying those instructions, and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A face recognition system, comprising:
an image pre-processing module configured to receive a subject facial image and at least one reference facial image,
wherein the image pre-processing module is configured to perform pose and lighting correction processing on the subject facial image to generate a corrected subject facial image and configured to perform pose and lighting correction processing on at least one reference facial image to generate at least one corrected reference facial image;
a face matching module coupled to the image pre-processing module and configured to perform facial recognition analysis of the corrected subject facial image with at least one reference facial image to generate facial recognition results; and
an output module coupled to the face matching module and configured to receive facial recognition results from the face matching module, wherein the output module is configured to manage the operation of the face recognition system including the operation of the face recognition system based on the facial recognition results received from the face matching module.

2. The system as recited in claim 1, wherein the image pre-processing module is configured to perform at least one of adjusting the pose of a face in a facial image, adjusting the lighting in a facial image, and adjusting the resolution of a face in a facial image.

3. The system as recited in claim 1, wherein the face recognition system operates in an identification mode application wherein the face matching module compares the subject facial image with at least one reference facial image from a facial image database.

4. The system as recited in claim 3, wherein the image pre-processing module includes a subject image pre-processing module configured to perform pose and lighting correction processing on a subject facial image captured from a camera or video recorder and a reference image pre-processing module configured to perform pose and lighting correction processing on at least one reference facial image received from the facial image database.

5. The system as recited in claim 3, wherein the face matching module is configured to generate a ranked list of possible matches of reference facial images to the subject facial image.

6. The system as recited in claim 1, wherein the face recognition system operates in a verification mode application wherein the face matching module compares the subject facial image with a reference facial image having an associated known identity with the subject facial image.

7. The system as recited in claim 6, wherein the image pre-processing module includes a subject image pre-processing module configured to perform pose and lighting correction processing on a subject facial image captured from a camera or video recorder and a reference image pre-processing module configured to perform pose and lighting correction processing on the reference facial image having an associated known identity with the subject facial image.

8. The system as recited in claim 6, wherein the face matching module is configured to determine whether or not the subject facial image and the reference facial image are facial images of the same person.

9. The system as recited in claim 6, wherein the reference facial image having an associated known identity with the subject facial image is retrieved from a data source including at least one of a facial image database, a smart card having at least one reference facial image having an associated known identity with the subject facial image, a passport photo having an associated known identity with the subject facial image, and an epassport having a reference facial image having an associated known identity with the subject facial image.

10. The system as recited in claim 1, further comprising a testing module that is configured to perform at least one of a False Accept Rate (FAR) test, a False Reject Rate (FRR) test, a CyberExtruder False Accept Rate (CEFAR) test and a Quality test on face recognition results generated by the face recognition system.

11. A method for face recognition, comprising:
receiving a subject facial image and at least one reference facial image;
performing pose and lighting correction processing on at least one of the subject facial image to generate a corrected subject facial image and the reference facial image to generate a corrected reference facial image;
performing facial recognition analysis of the corrected subject facial image with at least one reference facial image to generate facial recognition results; and
managing the operation of the face recognition method including the operation of the face recognition method based on the facial recognition results.

12. The method as recited in claim 11, wherein performing pose and lighting correction processing includes performing at least one of adjusting the pose of a face in a facial image, rotating the pose angle of the face in a facial image, adjusting the lighting in a facial image, and adjusting the resolution of a face in a facial image.

13. The method as recited in claim 11, wherein performing facial recognition analysis includes at least one of comparing the subject facial image with at least one reference facial image from a facial image database as part of an identification mode application and comparing the subject facial image with a reference facial image having an associated known identity with the subject facial image as part of a verification mode application.

14. The method as recited in claim 13, wherein performing pose and lighting correction processing includes performing pose and lighting correction processing on a subject facial image captured from a camera or video recorder and performing pose and lighting correction processing on at least one reference facial image received from a facial image database as part of the identification mode application.

15. The method as recited in claim 13, wherein performing facial recognition analysis includes generating a ranked list of possible matches of reference facial images to the subject facial image as part of the identification mode application.

16. The method as recited in claim 13, wherein performing pose and lighting correction processing includes performing pose and lighting correction processing on a subject facial image captured from a camera or video recorder and performing pose and lighting correction processing on a reference facial image having an associated known identity with the subject facial image as part of the verification mode application.

17. The method as recited in claim 13, wherein performing facial recognition analysis includes determining whether or not the subject facial image and the reference facial image are facial images of the same person, as part of the verification mode application.

18. The method as recited in claim 11, further comprising performing at least one of a False Accept Rate (FAR) test, a False Reject Rate (FRR) test, a CyberExtruder False Accept Rate (CEFAR) test and a Quality test on the generated facial recognition results.

19. A non-transitory computer readable medium having instructions stored thereon which, when executed by a processor, carry out a method for face recognition, the instructions comprising:
instructions to receive a subject facial image and at least one reference facial image;
instructions to perform pose and lighting correction processing on at least one of the subject facial image to generate a corrected subject facial image and the reference facial image to generate a corrected reference facial image;
instructions to perform facial recognition analysis of the corrected subject facial image with at least one reference facial image to generate facial recognition results; and
instructions to manage the operation of the face recognition method including the operation of the face recognition method based on the facial recognition results.

20. The non-transitory computer readable medium as recited in claim 19, wherein instructions to perform pose and lighting correction processing includes at least one of instructions to adjust the pose of a face in a facial image, instructions to rotate the pose angle of the face in a facial image, instructions to adjust the lighting in a facial image, and instructions to adjust the resolution of a face in a facial image.
